(19) United States
(12) Patent Application Publication
(10) Pub. No.: US 2010/0103643 A1
(43) Pub. Date: Apr. 29, 2010

(54) LENS FOR USE IN FLASH LAMP

(75) Inventors: Kuang-Wei Lin, Tu-Cheng (TW); Hsin-Tsung Yeh, Tu-Cheng (TW); Wei-Hsiu Chang, Tu-Cheng (TW); Chun-Hsiang Huang, Tu-Cheng (TW); Kuan-Ting Chen, Tu-Cheng (TW); Mei-Chun Lin, Chu-Nan (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/409,529

(22) Filed: Mar. 24, 2009

(30) Foreign Application Priority Data
Oct. 24, 2008 (CN) 200810305184.7

(51) Int. Cl. G03B 15/02; G02B 3/08

(52) U.S. Cl. 362/16; 359/741

(57) ABSTRACT

A lens includes an incidence surface and an emission surface. The emission surface includes an effective area and a non-effective area around the effective area. The non-effective area includes a first effective area located at the center of the effective area and a second effective area around the first effective area. The first effective area is three fifths of the effective area. A number of recesses formed on the surface of the first effective area and substantially over the entire first effective area.

### TECHNICAL FIELD

The present disclosure relates to optical lenses and, particularly, to a lens for use in flash lamp.

### BACKGROUND

Generally, flash lamps are used in electronic devices for providing an instantaneous flash of artificial light for camera modules of electronic devices. A flash lamp typically includes a light source and a lens. The lens is embedded in the shell of an electronic device on which the flash lamp is installed, enclosing the light source therein, to protect the light source from being damaged. In addition, the lens is used for equalizing light emitted from the light source.

To obtain an uniformity of light, a number of recesses are formed on the outer surface of the lens. The recesses are distributed over the entire outer surface of the lens. Being such structured, the portion of the recesses distributed at the periphery of the outer surface of the lens also disperses light transmitted therethrough out of the main illumination area of the flash lamp. Brightness of the periphery of the main illumination area may be greatly smaller than that of the center of the illumination area, thereby decreasing the uniformity of light. Further, the brightness uniformity of the flash lamp is greatly effected by the assembly precision of the lens.

What is needed, therefore, is a lens to overcome the above-mentioned problems.

### BRIEF DESCRIPTION OF THE DRAWINGS

FIG. 1 is a planar, schematic view of a lens, according to an exemplary embodiment.

FIG. 2 is a partially cross-sectional view of the lens in FIG. 1 taken along the line II-II of FIG. 1.

FIG. 3 is a schematic view of a testing screen for testing brightness uniformity of a flash lamp which employs the lens of FIG. 1.

FIG. 4 is a reproduction of simulated view showing brightness distribution of the testing screen of FIG. 3, which is illuminated by a flash lamp having the lens of FIG. 1 assembled thereto.

FIGS. 5-8 are reproduction of simulated views showing brightness distribution of the testing screen of FIG. 3, which is illuminated by a flash lamp having the lens of FIG. 1 assembled thereto with different deviations.

### DETAILED DESCRIPTION OF THE EMBODIMENTS

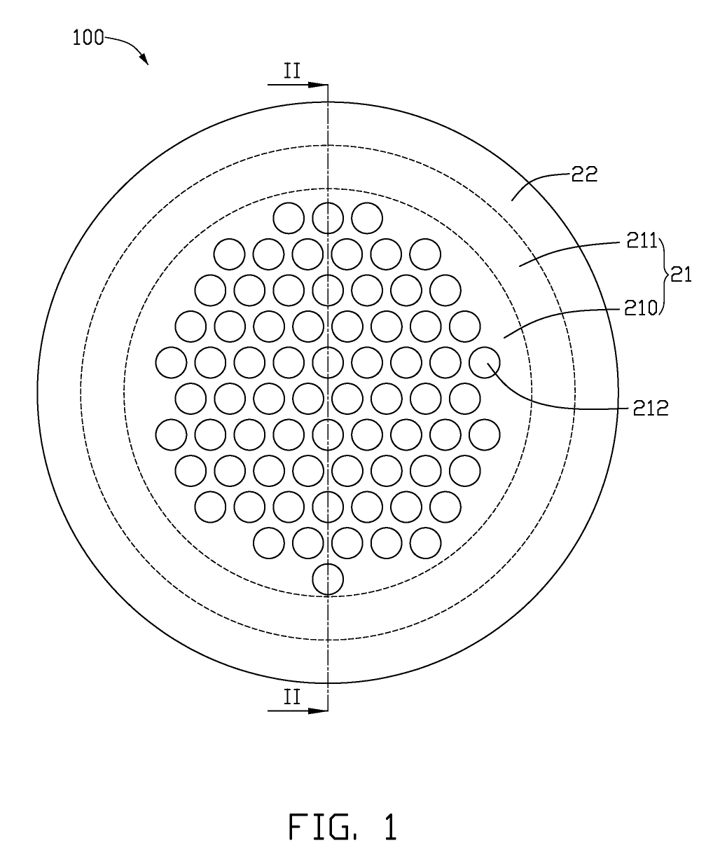

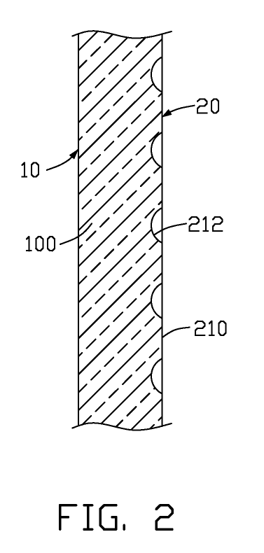

Referring to FIG. 1 and FIG. 2, a lens 100, according to an exemplary embodiment, is shown. The lens 100 can be used in a flash lamp (not shown) of an electronic device to improve brightness uniformity of the flash lamp. The lens 100 can be arranged in front of the light source of the flash lamp. The lens 100 includes an incidence surface 10 facing the light source and an emission surface 20. The emission surface 20 includes an effective area 21 for transmitting light, and a non-effective area 22 surrounding the effective area 21.

The effective area 21 includes a first effective area 210 at the center of the effective area 21, and a second effective area 211 surrounding the first effective area 210. The first effective area 210 is about three fifths of the area of the effective area 21.

A number of recesses 212 are formed on the first effective area 210. The recesses 212 are micro-sized and substantially fill the first effective area 210. The recesses 212 can be formed on the first effective area 210 by etching or grinding. The second effective area 211 is smooth. Furthermore, the recesses 212 also can be formed on the non-effective area 22.

Each of the recesses 212 is spherical and has a predetermined radius.

The lens 100 can be shaped as a circle, a rectangle, an ellipse, etc.

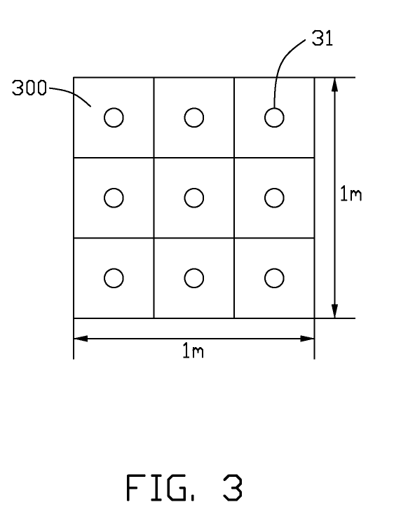

The uniformity of light emitting from the lens 100 can be measured by testing. Referring to FIG. 3, a 1 m×1 m square testing screen 300 is used in the test. The testing screen is placed 1 m in front of the lens 100. Nine testing points 31 are selected, the luminance (LUX) of each point 31 is detected by a corresponding luminometer (not shown), and the brightness uniformity value is calculated by the follow formula:

$$\frac{LUX ( min )}{LUX ( max )} \times 100 \%$$

wherein, the LUX(min) is the detected smallest luminance of the testing points, the LUX(max) is the detected largest luminance of these points. The larger the brightness uniformity value is, the better the brightness uniformity of the lens is.

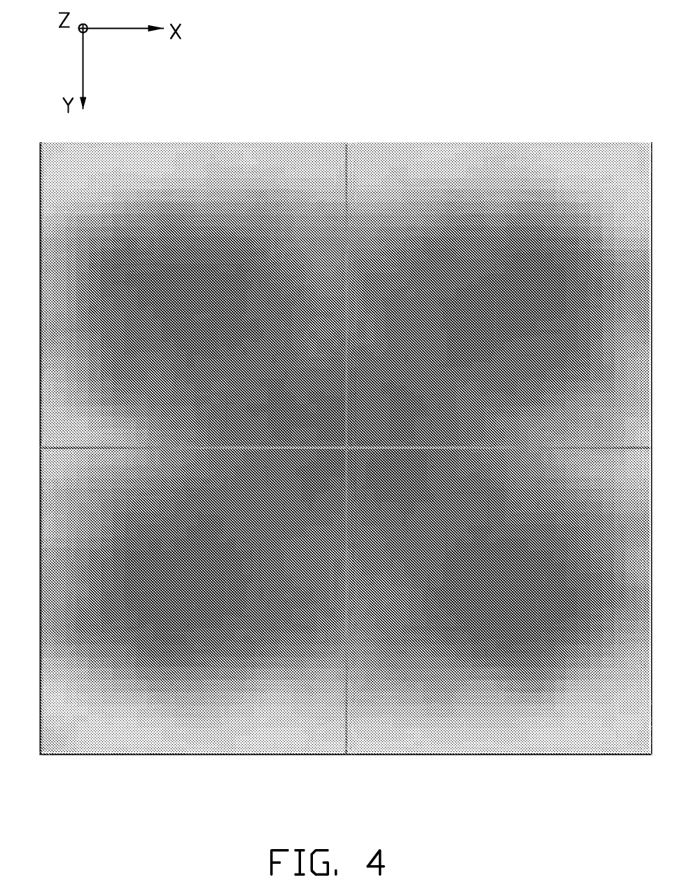

Referring to FIG. 4, a reproduction of a simulated view of brightness uniformity of the light emitted from the lens 100 (see FIG. 1) is shown. Wherein, the darker portion represents the high brightness portion, the lighter portion represent the low brightness portion. An example of the brightness uniformity value is 79%. As compared with ordinary lens for which the detected brightness uniformity is about 54%, the brightness uniformity of the flash lens employing the lens 100 is greatly improved.

Being such structured, the lens 100 also can prevent the brightness uniformity of the flash lamp from being greatly effected by the assembly precision of the lens 100.

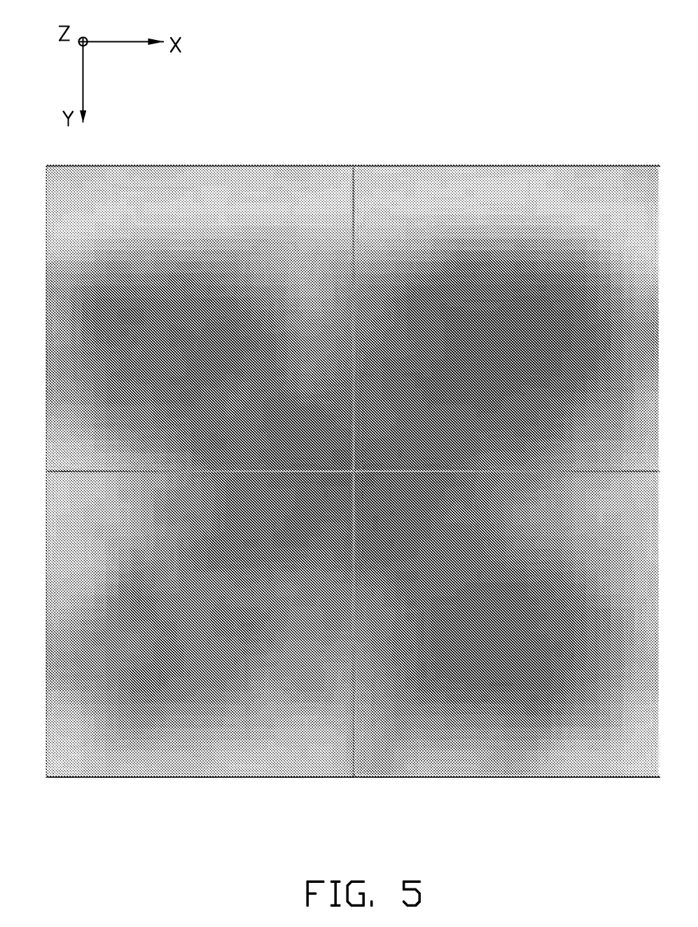

As shown in FIG. 5, brightness uniformity of a flash lamp is detected. In this flash lamp, the lens 100 is deviated from the desired position 0.1 mm along both x-axis and y-axis directions, and 0.15 mm along z-axis direction. However, the detected brightness uniformity value reach up to about 73.3%.

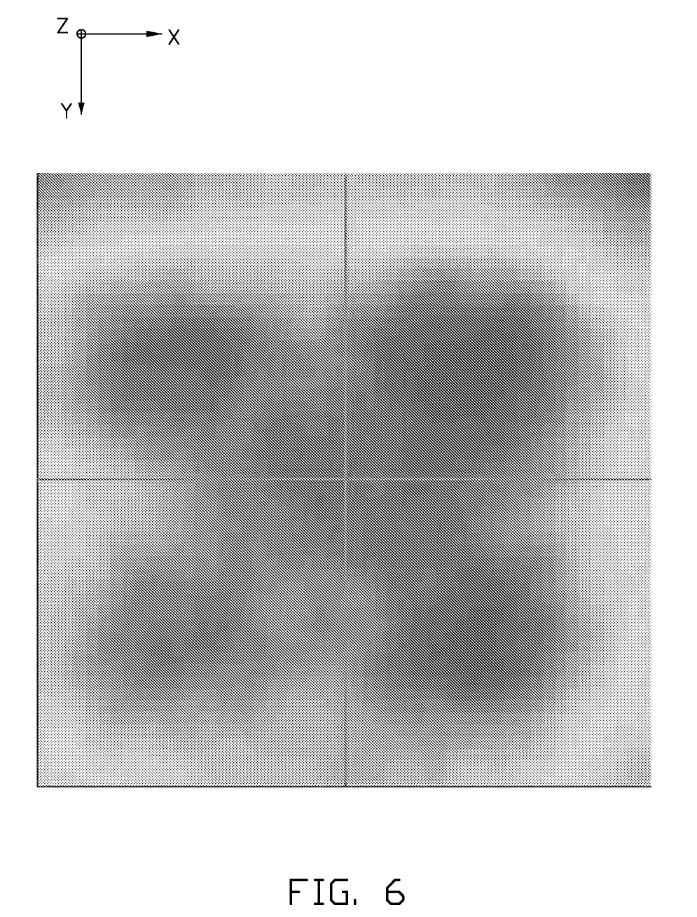

In FIG. 6, in this case, the lens 100 is deviated from the desired position 0.1 mm along x-axis direction, 0.1 mm along y-axis direction, and 0.15 mm along z-axis direction. The detected brightness uniformity value reach up to about 71.9%.

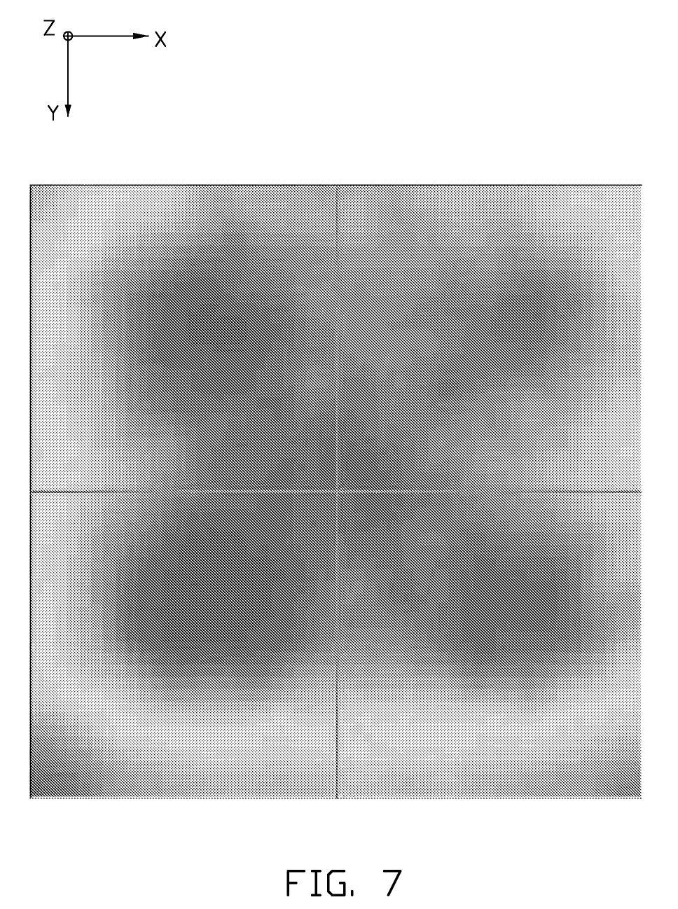

Referring to FIG. 7, in this case, the lens 100 is deviated from the desired position −0.1 mm along x-axis direction, −0.1 mm along y-axis direction, and 0.15 mm along z-axis direction. The detected brightness uniformity value reach up to about 71.6%.

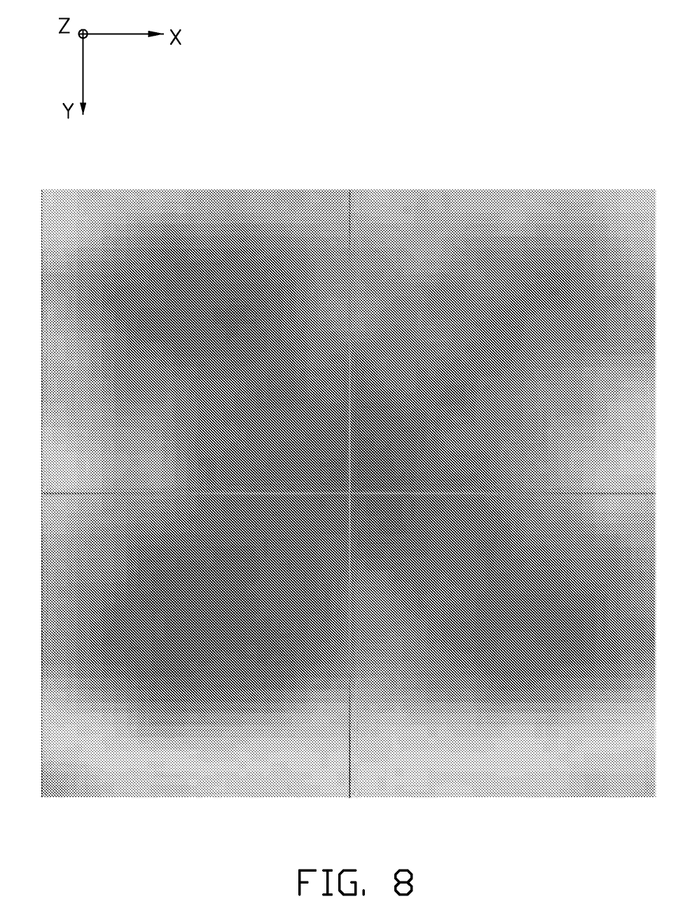

Referring to FIG. 8, in this case, the lens 100 is deviated from the desired position −0.1 mm along x-axis direction, −0.1 mm along y-axis direction, and −0.15 mm along z-axis direction. The detected brightness uniformity value reach up to about 72.8%.

Therefore, the lens 100 also can keep a steadily high brightness uniformity of the light emitted from the lens 100 even with an assembly error.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A lens for use in a flash lamp, comprising:
an emission surface, comprising:
an effective area, capable of transmitting light, comprising:
a first effective area located at the center of the effective area, the first effective area being about three fifths of the area of the effective area and defining a plurality of recesses thereon, which are distributed substantially over the entire first effective area.

2. The lens as claimed in claim 1, wherein each of the recesses is a spherical surface with a predetermined radius.

3. The lens as claimed in claim 2, wherein the recesses are micro-sized.

4. The lens as claimed in claim 2, wherein the plurality of recesses are formed on the first effective area by a technique selected from the group consisting of etching and grinding.

5. The lens as claimed in claim 2, wherein the emission surface also comprises a non-effective area located at the inner periphery of the emission surface, the non-effective area defines a plurality of recesses thereon.

6. A flash lamp comprising:
a light source; and
a lens, arranged in front of the light source, comprising:
an incidence surface facing the light source; and
an emission surface, opposite to the incidence surface, comprising:
an effective area, capable of transmitting light, comprising:
a first effective area located at the center of the effective area, the first effective area being about three fifths of the area of the effective area and defining a plurality of recesses thereon, which are distributed substantially over the entire first effective area.

7. The flash lamp as claimed in claim 6, wherein each of the recesses is a spherical surface with a predetermined radius.

8. The flash lamp as claimed in claim 7, wherein the recesses are micro-sized.

9. The flash lamp as claimed in claim 7, wherein the plurality of recesses are formed on the first effective area by a technique selected from the group consisting of etching and grinding.

10. The flash lamp as claimed in claim 7, wherein the emission surface also comprises a non-effective area located at the inner periphery of the emission surface, the non-effective area defines a plurality of recesses thereon.
